(19) United States
(12) Patent Application Publication
(10) Pub. No.: US 2021/0161265 A1
(43) Pub. Date: Jun. 3, 2021

(54) CASES FOR STORING LASH EXTENSIONS AND METHODS FOR USE AND MANUFACTURE THEREOF

(71) Applicant: Lashify, Inc., Los Angeles, CA (US)

(72) Inventor: Sahara Lotti, Los Angeles, CA (US)

(21) Appl. No.: 16/644,948

(22) PCT Filed: Oct. 19, 2019
(86) PCT No.: PCT/US2019/057104

§ 371 Date: Mar. 5, 2020

Related U.S. Application Data
(60) Provisional application No. 62/748,335, filed on Oct. 19, 2018.

(51) Int. Cl. A45C 11/00; A41G 5/02

(52) U.S. Cl. CPC A45C 11/008; B65D 85/00; A41G 5/02

(57) ABSTRACT

An applicator comprising: a first arm having a first grasping tip that is arcuate, wherein the first grasping tip has a first inner side hosting a male portion; and a second arm having a second grasping tip that is arcuate, wherein the second grasping tip has a second inner side hosting a female portion, wherein the first inner side faces the second inner side, wherein the male portion and the female portion avoid mating when the first arm and the second arm are at a default position, wherein the male portion and the female portion mate when the first arm and the second arm are at a grasping position.

### CROSS REFERENCE TO RELATED APPLICATIONS

The present application claims the benefit of U.S. Provisional Application Ser. No. 62/748,335 filed 19 Oct. 2018; the contents of which is incorporated herein by reference in its entirety.

### TECHNICAL FIELD

This disclosure relates to cases for storing lash extensions.

### BACKGROUND

A lash extension can be stored in a case. However, the lash extension can be displaced from the case during transport, which can damage the lash extension or result in the lash extension being lost.

### SUMMARY

Broadly, this disclosure enables various cases for storing lash extensions and methods of use and manufacture thereof. In particular, these cases can include gaskets or inclined floors, which can help the lash extensions to avoid being displaced from the case during transport.

In an embodiment, a case comprises: a lid; a gasket; a body coupled to the lid such that the body and the lid define a window and such that the gasket is positioned between the lid and the body, the window being configured to enable a lash extension having a base and a plurality of hairs extend out of the window as the gasket resiliently contacts the base or the hairs.

One embodiment of a method of manufacturing a case for carrying artificial eyelash extensions may include providing a lid, providing a gasket, and providing a body. The lid may be coupled to the body such that the body and the lid define a window. The gasket may be coupled to either the lid or the body between the lid and the body, where the window may be configured to enable a lash extension having a base and a plurality of hairs that extend out of the window as the gasket resiliently contacts the base or the hairs.

### DESCRIPTION OF DRAWINGS

FIGS. 1-6 show an embodiment of a case for hosting a plurality of artificial lash extensions according to this disclosure.

FIG. 7 shows an embodiment of a lid hosting a visual indicia thereon according to this disclosure.

FIG. 8 shows an embodiment of a lid and a body according to this disclosure.

FIG. 9 shows an embodiment of a gasket and an inclined floor according to this disclosure.

FIGS. 10-33 show an embodiment of a case where a gasket is separate and distinct from a lid and a body according to this disclosure.

### DETAILED DESCRIPTION

Broadly, this disclosure enables various cases for storing lash extensions and methods of use and manufacture thereof. In particular, these cases can include gaskets or inclined floors, which can help the lash extensions to avoid being displaced from the case during transport.

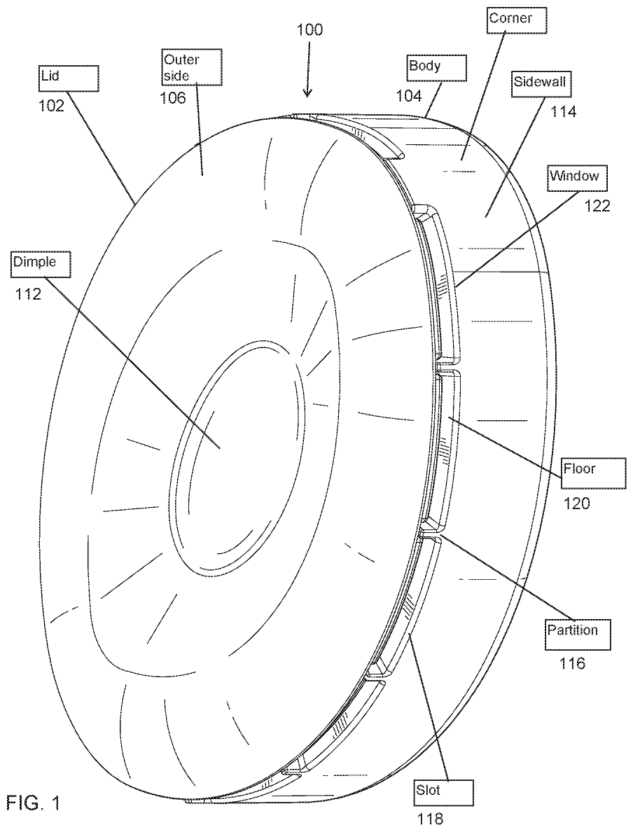

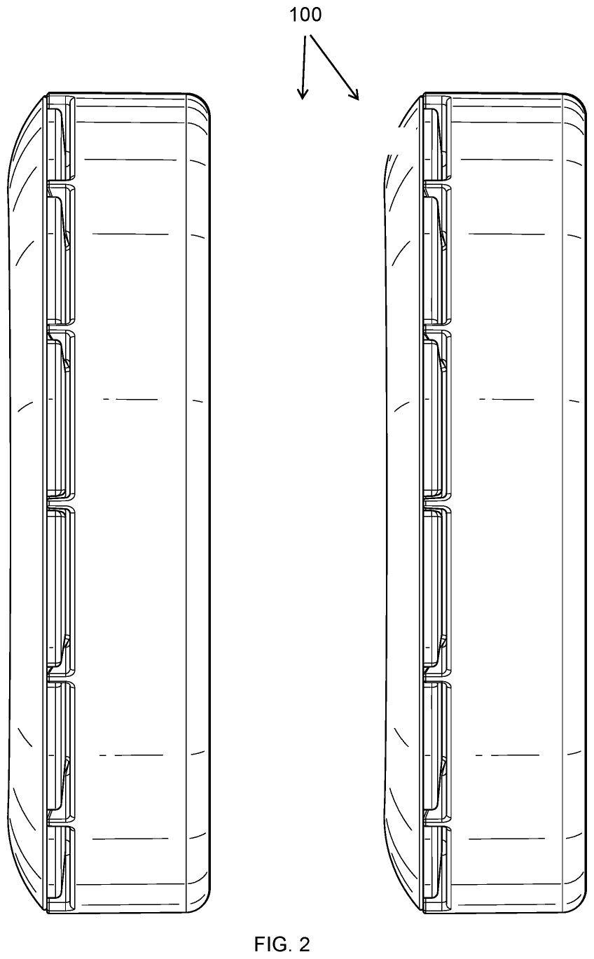

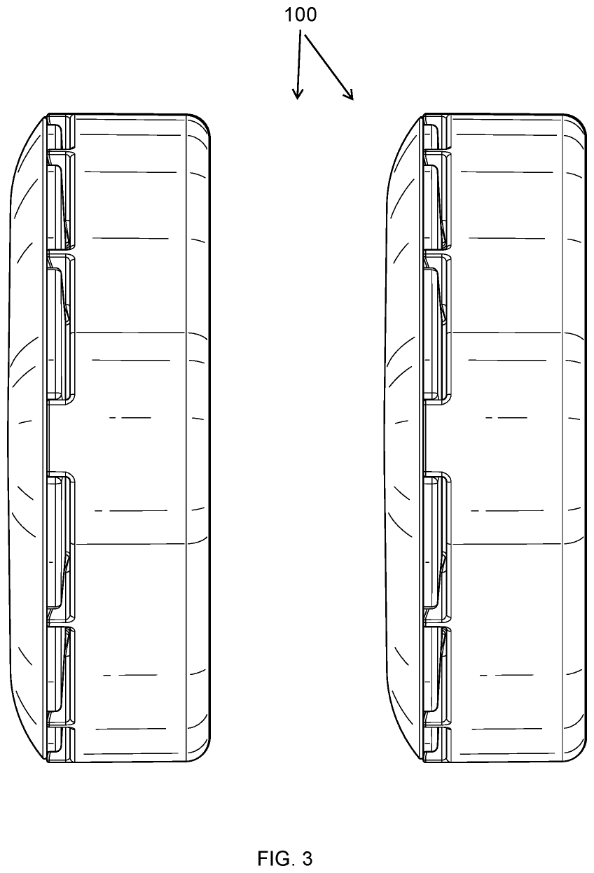

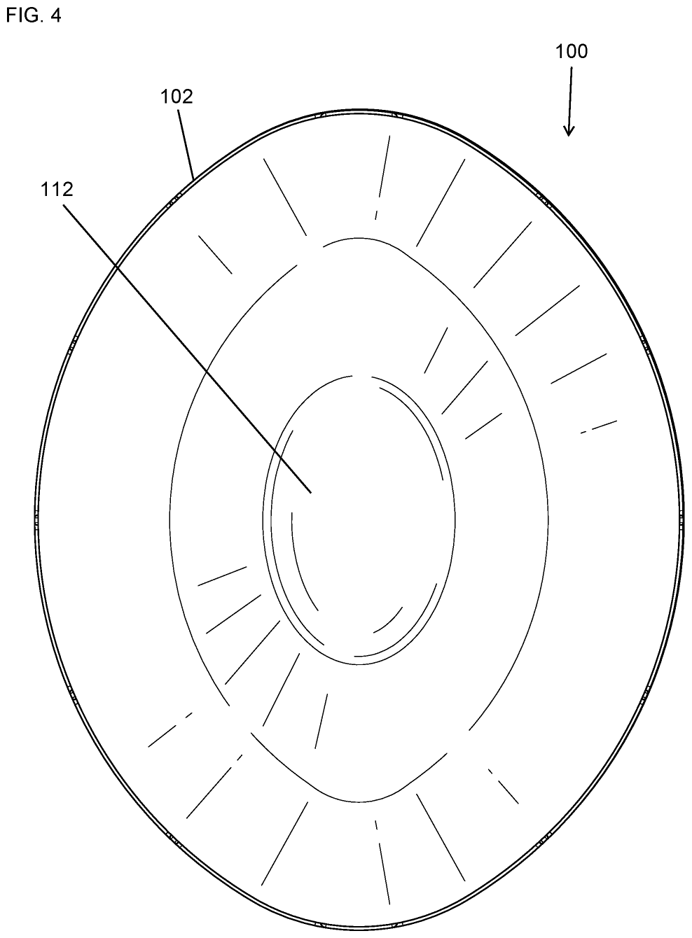

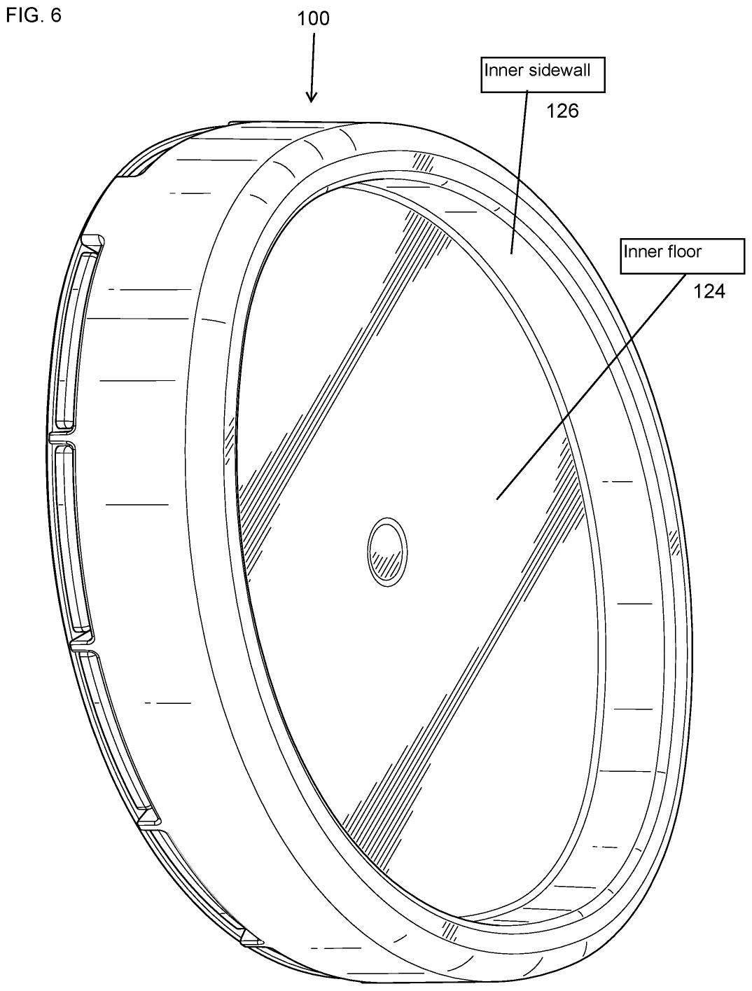

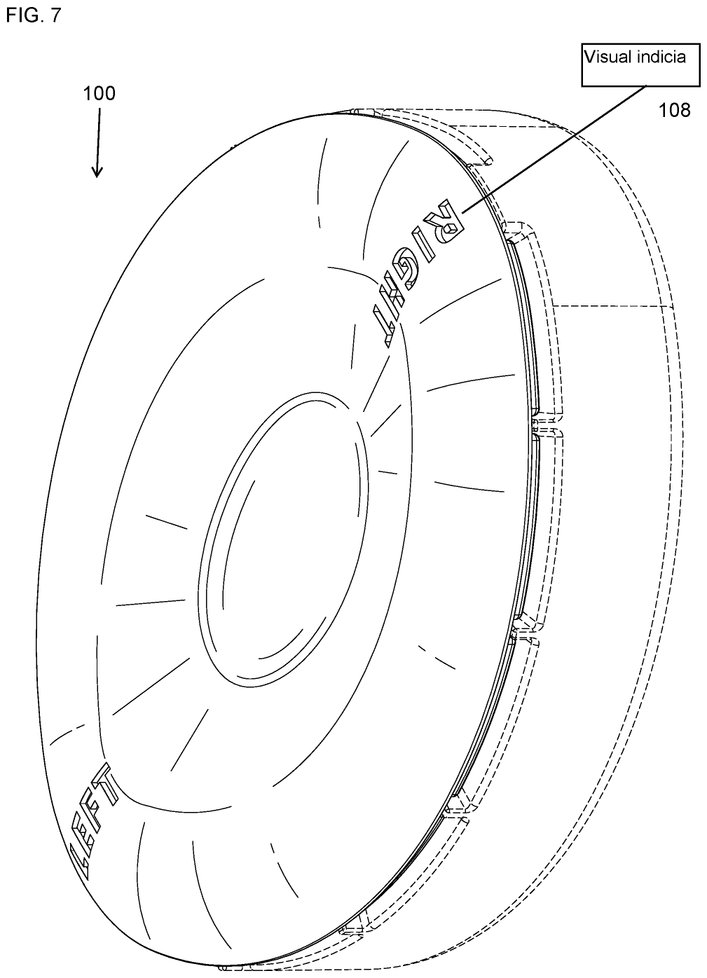

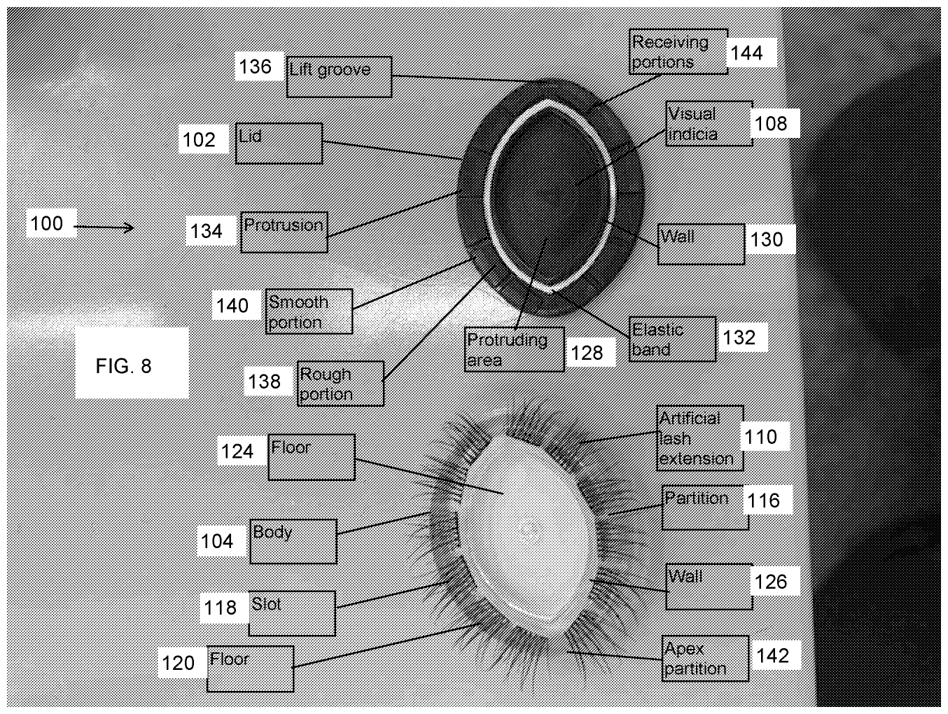

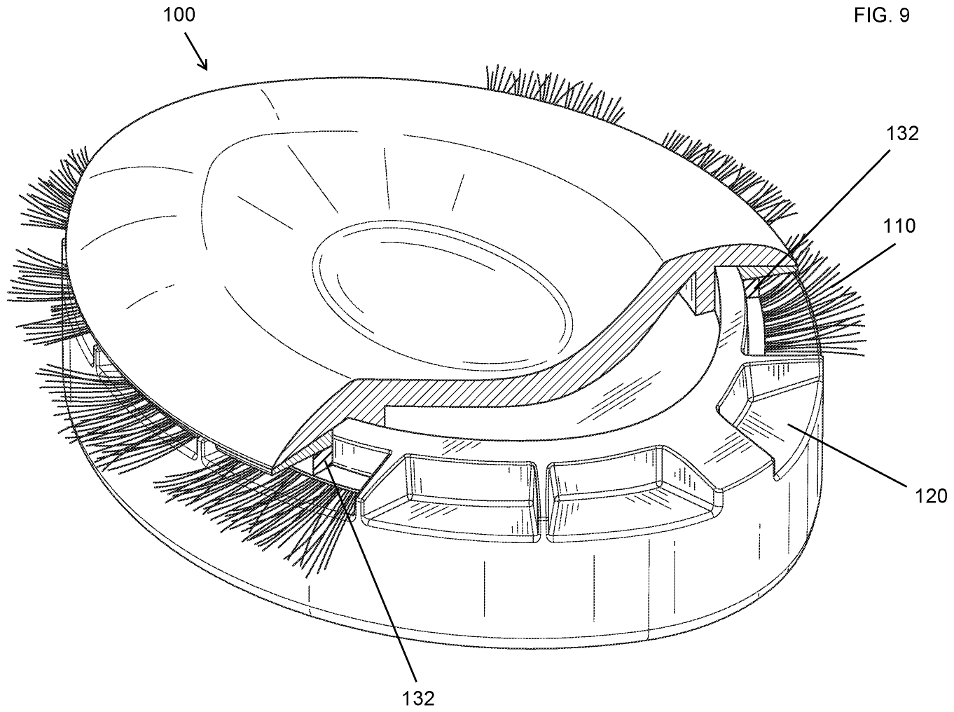

FIGS. 1-6 show an embodiment of a case for hosting a plurality of artificial lash extensions according to this disclosure. FIG. 7 shows an embodiment of a lid hosting a visual indicia thereon according to this disclosure. FIG. 8 shows an embodiment of a lid and a body according to this disclosure. FIG. 9 shows an embodiment of a gasket and an inclined floor according to this disclosure. In particular, a case 100 has a lid 102 and a body, housing, or pedestal 104.

The lid 102 includes plastic, but can include other materials, such as metal, rubber, wood, foam, or others. The lid 102 is opaque, but can be transparent or translucent. The lid 102 is eye-shaped, although other shapes are possible, whether open-shape or closed-shape, whether symmetrical or asymmetrical, such as a circle, square, rectangle, pentagon, octagon, triangle, trapezoid, or any other polygonal shape. The lid 102 sits or rests on the body, which can be securely, such as via mating, fastening, interlocking, adhering, magnetizing, hook-and-looping, or others.

The lid 102 has an outer side 106 that can host various visual indicia 108 thereon, such as a brand indicia, an orientation indicia, a type or sub-type of artificial lash extension or others. The visual indicia 108 can include alphanumerics and images, whether adhered, stamped, engraved, embossed, holographic, barcode, QR code, augmented reality marker, or others. For example, a kit, a package, a container, an envelope, a box, an intermodal container, or a system can include a plurality of artificial lash extension types 110 each of which can be solely hosted in the case 100 and the lid 102 of the case 100 can host a visual indicia 108 of type of artificial lash extension 110 or others (e.g., B.12 or A.14 or C.10). The outer side 106 hosts an inward central dimple 112, although a flat surface or a central or offset bump or offset inward dimple is possible. The inward central dimple 112 can host the visual indicia 108.

The body 104 includes plastic, but can include other materials, such as metal, rubber, wood, foam, or others. The body 104 is translucent, but can be opaque or transparent. The body 104 is configured to support the lid 102, which can be securely, such as via mating, fastening, interlocking, adhering, magnetizing, hook-and-looping, or others. The body 104 is internally structured to accommodate for the central inward dimple 112 of the lid 102.

The body 104 has an outer sidewall 114 with an outer side that is longitudinally eye-shaped, although other shapes are possible, whether open-shape or closed-shape, whether symmetrical or asymmetrical, such as a circle, square, rectangle, pentagon, octagon, triangle, trapezoid, or any other polygonal shape. The outer sidewall 114 hosts a plurality of vertical partitions 116 that define a plurality of storage slots 118 (e.g., ledges) structured for storing the artificial lash extensions 110, such as in a one-to-one correspondence, although other types of correspondences are possible, such as one storage slot 118 for at least two artificial lash extensions 110 stacked one on top of another or positioned side-by-side in any orientation. At least one of the vertical partitions 116 can have a top surface that is level or inclined, whether inwardly or outwardly. For example, at least one of the vertical partitions 116 can be square, rectangular, oval, arcuate, triangular, pyramidal, dome, wedged, or another shape.

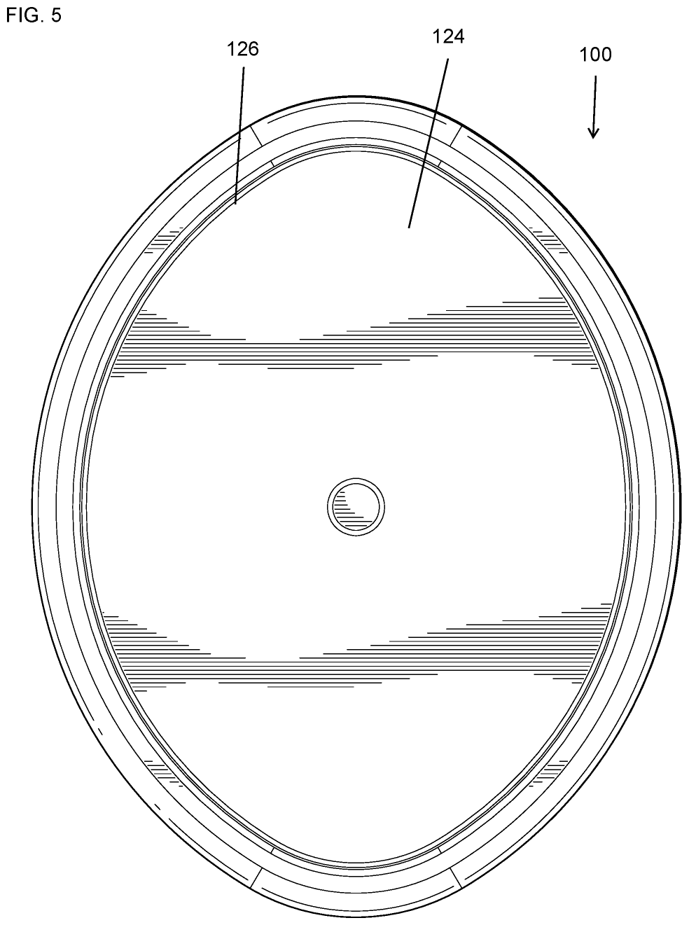

Each of the slots 118 has a floor 120 extending between a pair of vertical partitions 116 such that a U-shaped or C-shaped or V-shaped or W-shaped area is defined (e.g., at least one of the vertical partitions 116 can be acute, obtuse or perpendicular relative to the floor 120). The floor 120 extends up to an outer side of an inner sidewall 126, which contacts (e.g., at a perpendicular, acute, obtuse angle) an inner central floor 124 that faces the inward projection of the inward central dimple 112, as shown in FIG. 8. Note that the inner floor 124 can be lacking as well such that the inward projection of the inward central dimple 112 is exposed. The outer side of the inner sidewall 126 is longitudinally eye-shaped, as shown in FIGS. 5 and 8, although other shapes are possible, whether open-shape or closed-shape, whether symmetrical or asymmetrical, such as a circle, square, rectangle, pentagon, octagon, triangle, trapezoid, or any other polygonal shape. For example, at least one of the slots 118 can have a trapezoidal, square, or rectangular area. The outer side of the inner sidewall 126 structurally extends mimicking the outer side of the outer sidewall 114. The inner sidewall 126 defines an internal area into which the central inward dimple 112 of the lid 102 projects. The internal area can be used for storage, such as of a fluid, a gel, a powder, a physical item, or others. The floor 120 may or may not be coated with a friction enhancing or reducing coating. For example, the friction enhancing coating can be rubber. For example, the friction reducing coating can be polytetrafluoroethylene (PTFE), silicon, or others.

The floor 120 can be level or inclined relative to the outer sidewall 114, whether inward or outward (e.g., the floor 120 can be acute, obtuse or perpendicular relative to the outer sidewall 114). As shown in FIG. 9, this incline can be less than about 90 degrees, less than about 75 degrees, less than about 60 degrees, less than about 50 degrees, less than about 45 degrees, less than about 30 degrees, less than about 15 degrees, less than about 10 degrees, less than about 7 degrees, less than about 5 degrees, less than about 3 degrees, or others including any intermediate values. For example, when the floor 120 is acutely inclined inward toward the center of the case 100 at or less than about 30 degrees relative to the outside sidewall 114, then the artificial lash extension 110 stored therein can be propped up or angled upwards and less likely to fall out during use, such as transport of the case.

The floor 120 can be smooth or rough. For example, the floor 120 can be textured (e.g., parallel lines, intersecting lines) to reduce artificial lash extension 110 movement during use, such as transport of the case 100. The floor 120 can be textured in various ways, such as knurled, hatched, spiked, bumped, or others, whether inward or outward. The floor 120 can be grooved or ridged. For example, the floor 120 can host a plurality of longitudinal projections radially or non-radially projecting outwards (e.g., like rays of sun) toward the outer sidewall 114. For example, the floor 120 can host at least two parallel or non-parallel, rectilinear or non-rectilinear, continuous or discontinuous projections, which can have a U-shaped, C-shaped, D-shaped, B-shaped, W-shaped, V-shaped, or any other shaped projections.

The slots 118 can be equivalent or non-equivalent in volume when the lid 102 is positioned on the body 104 or vice versa. The slots 118 can have identical or non-identical window shape and/or size 122 when the lid 102 is positioned on the body 104 (e.g., vary in length or height). The slots 118 can reduce or not reduce in volume or area or window shape 122 as the slots 118 get closer to corners of the body 104 (e.g., artificial lash extensions 110 can vary in length or width or thickness at center relative to those at corners or artificial lash extensions 110 can be mixed and matched by users). The slots 118 can store an identically sized or structured artificial lash extensions 110, which can be or avoid being of same type. The slots 118 can store non-identically sized or structured artificial lash extensions 110, which may or may not be of same type. For example, the case 100 can store an identically sized or structured artificial lash extensions 110 (e.g., specific artificial lash extension type or identical in length of hairs extending from base or length of base or number of hair clusters per base or hair thickness). For example, a fused bundle of hairs can be between about 30 to about 40 hairs, which can be between about 30-35, which can be between about 31-33.

When the lid 102 is secured onto the body 104 and the slots 118 contain the artificial lash extensions 110, the lid 102 and the body 104 structurally cooperate not to apply undue pressure onto the artificial lash extensions 110 (e.g., protect the curls of the artificial lash extensions 110 and minimize downward pressure from the lid 102) yet structurally cooperate so that the artificial lash extensions 110 do not fall out from the case 100.

FIG. 8 shows an example of the case 100 being open, with the case 100 having the lid 102 and the body 104 detached from each other, as described herein. The lid 102 is opaque, but can be transparent or translucent. The lid 102 has an inner side (e.g., underside) that hosts a central outwardly protruding area 128 that corresponds to the central inwardly protruding dimple 112, as described herein. The central outwardly protruding area 128 centrally hosts the visual indicia 108 corresponding to a type of artificial lash extensions that are stored in this case 100, as described herein. Note that the visual indicia 108 can be non-centrally hosted as well. The central outwardly protruding area 126 can also be non-protruding, such as flat or inwardly dimpled.

The central outwardly protruding area 128 is surrounded by a wall 130 (e.g., continuous, discontinuous, solid, perforated) that extends from the inner side (e.g., perpendicularly, acutely, obtusely) of the lid 102. The wall 130 is longitudinally eye-shaped, although other shapes are possible, whether open-shape or closed-shape, whether symmetrical or asymmetrical, such as a circle, square, rectangle, pentagon, octagon, triangle, trapezoid, or any other polygonal shape.

The wall 130 may be surrounded by an elastic band 132, although a resilient, flexible, deformable, bendable, or non-rigid member is possible. The elastic band 132 may function as a gasket against the artificial lash extensions 110, as explained herein. The elastic band 132 can include rubber or foam or plastic, but other materials are possible, such as an inflatable balloon or a tubular container containing a fluid (e.g., liquid or gas) or sand or powder or beads/spheres (e.g., rigid or flexible or resilient) or others. The elastic band 132 is longitudinally continuous along the perimeter of the wall 130. However, the elastic band 132 can be a plurality of elastic strips spaced apart from each other, such as discontinuous. The elastic band 132 can be shaped as any closed or open shape (e.g., O-shape, C-shape, U-shape, V-shape, J-shape, D-shape, eye-shape, circle, square, triangle, pentagon, hexagon, octagon, polygon, symmetrical, asymmetrical, oval, ellipse, ovoid). The elastic band 132 can be generally closed-shaped, but specifically shapeless (e.g., dynamically changed depending on how held) before mounting over the wall 130 and then specifically shaped when mounted over the wall 130 to shapely correspond to the wall 130. The elastic band 132 can be specifically shaped before mounting over the wall 130 to correspond to the shape of the wall 130. The elastic band 132 can remain in place via elastic friction or inward pressure against the wall 130. The elastic band 132 can be attached or secured to the inner side (e.g., adhering, bonding, mating, hooking, fastening, interlocking, bracketing). The elastic band 132 can be or avoid being visually distinct from the lid 102 (e.g., color, hatching, patterns).

The inner side of the lid 102 hosts a plurality of protrusions 134 longitudinally spaced apart from each other and longitudinally extending around the elastic band 132. The protrusions 134 extend outwardly from the inner side of the lid 102 such that a plurality of hollow receiving portions 144 (e.g., U-shape, V-shape, C-shape) are defined therebetween. However, at both apexes of the inner side of the lid 102, the protrusions 134 define a pair of lift grooves 136 or open spaces (e.g., triangular, V-shaped, trapezoidal) therebetween, which can help in removing the lid 102 from the body 104 or vice versa (e.g., form a grasping area to apply a separation force). The protrusions 134 are unitary with the inner side of the lid 102 (e.g., molded, 3D printed, cast, stamped, routed) and include same material (e.g., plastic, rubber, metal). However, the protrusions 134 can also be attached to the inner side of the lid 102 (e.g., adhering, magnetizing, fastening, interlocking, mating, bonding).

The protrusions 134 can be identical or non-identical to each other in shape or volume per longitudinal side. The protrusions 134 are shaped as blocks (e.g., trapezoidal, cuboid, conical, D-shaped), whether symmetrical or asymmetrical. The protrusions 134 can change in volume or shape per longitudinal side (e.g., protrusions 134 closer to corners are smaller in volume or shape relative to protrusions 134 further from corners).

At least one of the protrusions 134 has an outer side that faces and contacts an artificial lash extension 110 when the lid 102 is positioned on the body 104 or vice versa and the body 104 stores the artificial lash extension 110 in the slot 118. This side has a rough area 138 proximal to the elastic band 132 and a smooth area 140 distal to the elastic band 132. The rough area 138 and the smooth area 140 are immediately adjacent to each other, although the rough area 138 and the smooth area 140 can be separated by an intermediate area. The rough area 138 can be coated with a friction enhancing material (e.g., rubber, plastic, foam) or include a textured portion (e.g., parallel lines, intersecting lines) to help in limiting movement of the artificial lash extension 110 in the slot 118 or from the slot 118 when the rough area 138 contacts the artificial lash extension 110 in the slot 118. The textured portion can be textured in various ways, such as knurled, hatched, spiked, bumped, or others, whether inward or outward. However, note that this side of the protrusion 134 can also lack the smooth area 140 or the rough area 138.

The body 104 includes the inner floor section 124 (e.g., flat, inwardly depressed, outwardly projected) that faces the protruding area 128 of the lid 102. However, the inner floor section 124 can be lacking as well. The inner floor section 124 is opaque, but can be transparent or translucent. The inner floor section 124 is surrounded by the wall 126 from which the partitions 116 extend radially and thereby define the slots 118 storing the artificial lash extensions 110 therein. The wall 126 has a pair of apex partitions 140 (e.g., triangular, V-shaped, trapezoid) that correspond to the lift grooves 136 of the lid 102 or vice versa.

When the case 100 is closed, the body 104 stores the artificial lash extensions 110 in the slots 118 between the partitions 116 and the lid 102 sits or rests on the body 104, which can be securely positioned, as described herein. During such state, the inner wall 130 of the lid 102 is concentrically engaged with the inner wall 126 of the body 104 (e.g., the inner wall 126 of body 104 is concentrically positioned between the elastic band 132 and the inner wall 130 of the lid 102). The partitions 116 of the body are received in the receiving portions 144. The lift grooves 136 face the apex partitions 142. The protrusions 134 face the slots 118 and contact the artificial lash extensions 110, which can be via the rough areas 138 of the inner sides to frictionally engage the artificial lash extensions 110, while ensuring that the artificial lash extensions 110 do not fall out from the slots 118, yet avoid applying or exerting undue pressure onto the artificial lash extensions 110, based on the elastic band 132 dynamically or resiliently or deformably flexing (e.g., like a gasket or a dynamic barrier), especially when the artificial lash extensions 110 are of different types (e.g., vary by length, width, thickness, hair material) or when the artificial lash extensions 110 are not of same type per longitudinal side of the body 104 (e.g., artificial lash extensions proximal 110 to corners differ relative to artificial lash extensions 100 distal from corners). Note that the elastic band 132 can be absent, but the lid 102 is then structured (e.g., angled floors 120 for sufficient clearance between the lid 102 and the artificial lash extensions 110) to avoid applying or exerting undue pressure onto the artificial lash extensions 110, while ensuring that the artificial lash extensions 110 do not fall out from the slots 118. In an embodiment, an adhesive or friction coating, for example, may be disposed on the floor 120 to help prevent the artificial lash extensions 110 from falling out of the slots 118. The amount and type of adhesive, of course, may be such that the artificial lash extensions 110 are not damaged when removed from the slots 118.

The case 100 may be partially or entirely composed of metal, plastic, or some other material (e.g., foam). For example, in some embodiments the case 100 includes a die case metal body (e.g., for strength and durability) having a smooth powder coating (e.g., for aesthetics and improved cleanability), while in other embodiments the case 100 includes a recyclable (i.e., disposable) plastic body that is not intended for significant durations of use (e.g., months or years). Those skilled in the art will recognize that any suitable material may be used. For example, in some embodiments plastic may be desirable because it is recyclable and resistant to the adhesives typically applied to lash fusions before fixation to an individual's natural lashes.

Moreover, the outer surfaces of the case 100 may be substantially smooth and continuous. Thus, the outer surfaces of these components may be substantially free of any gaps, ridges, or fasteners that would make cleaning difficult or that may inadvertently capture artificial lashes.

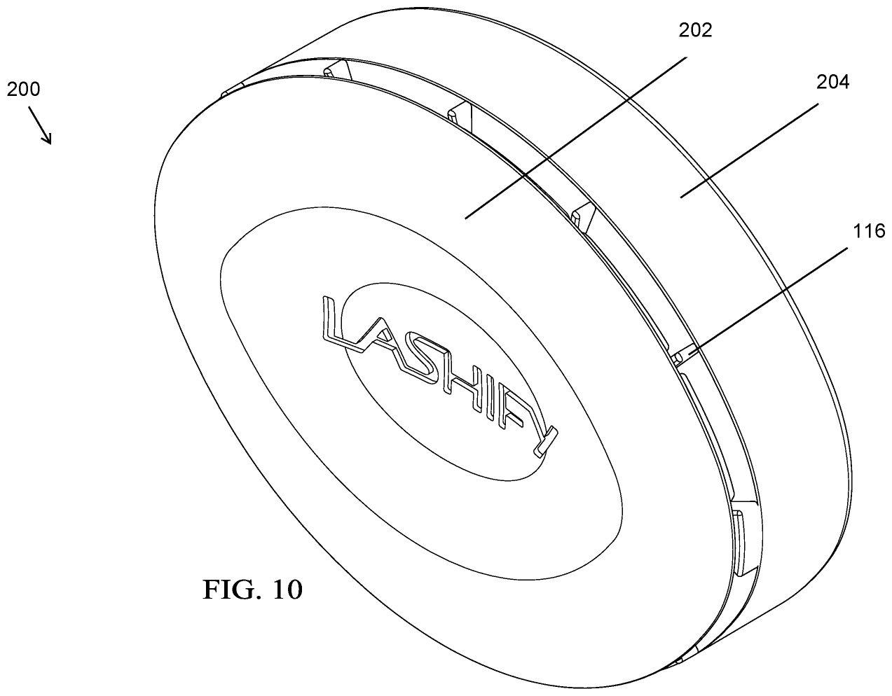

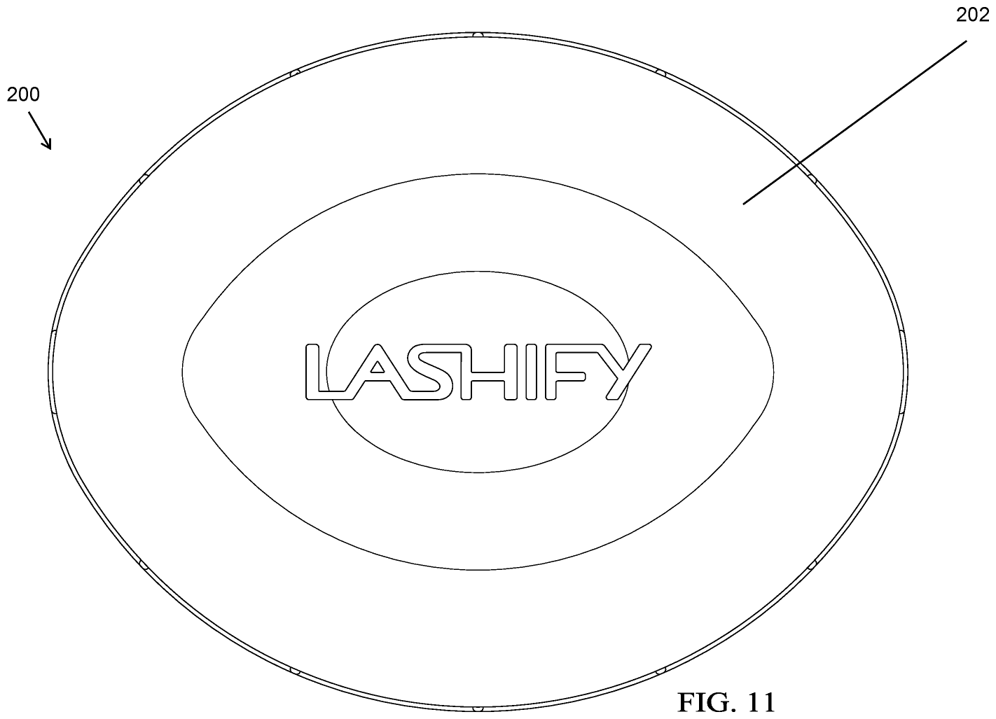

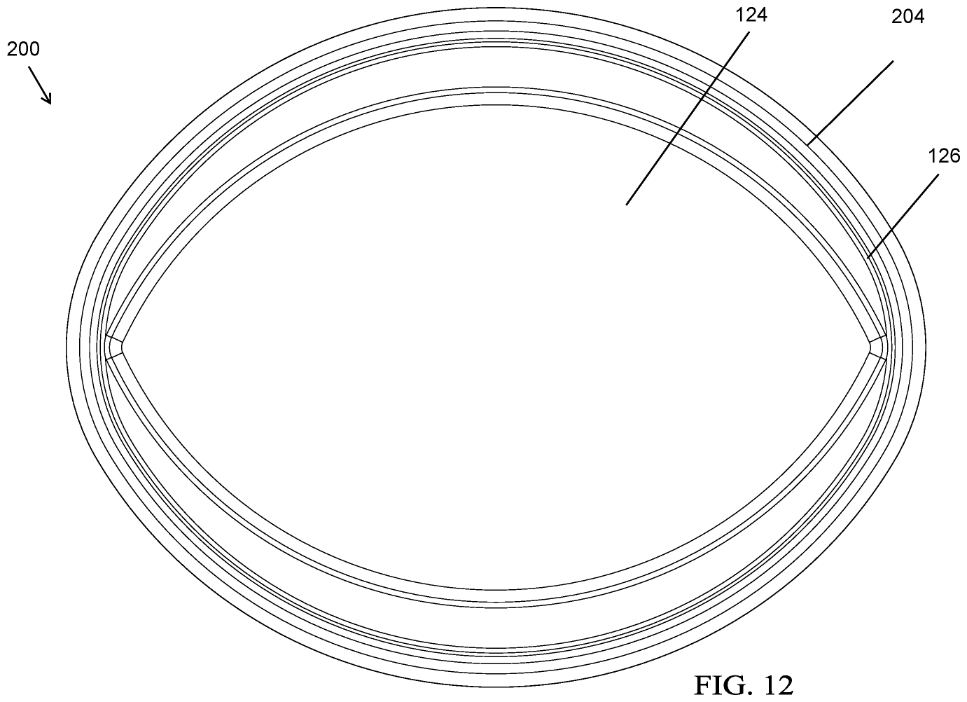

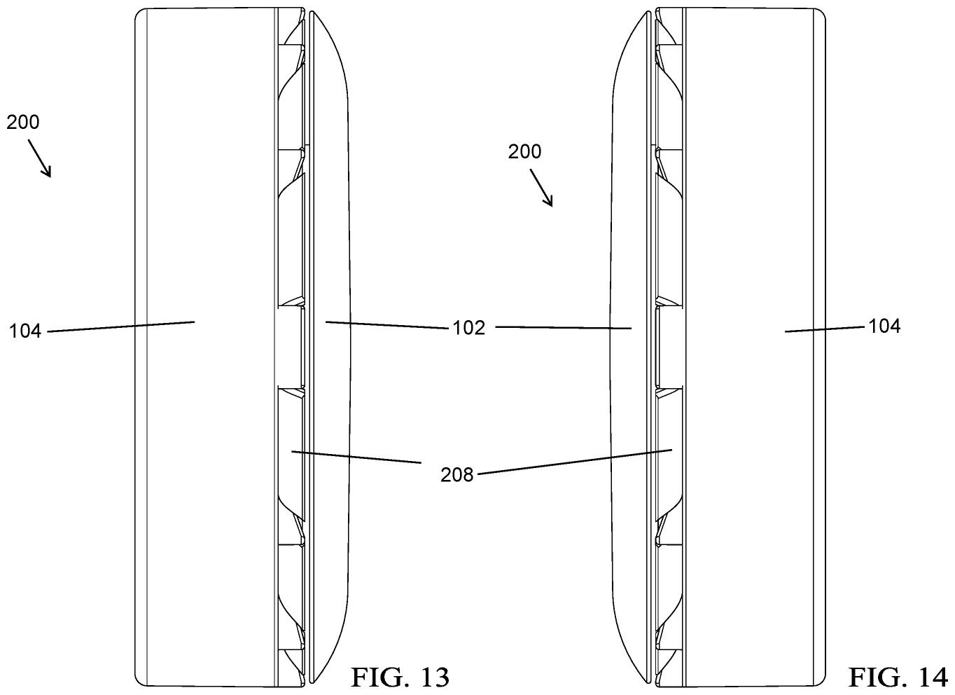

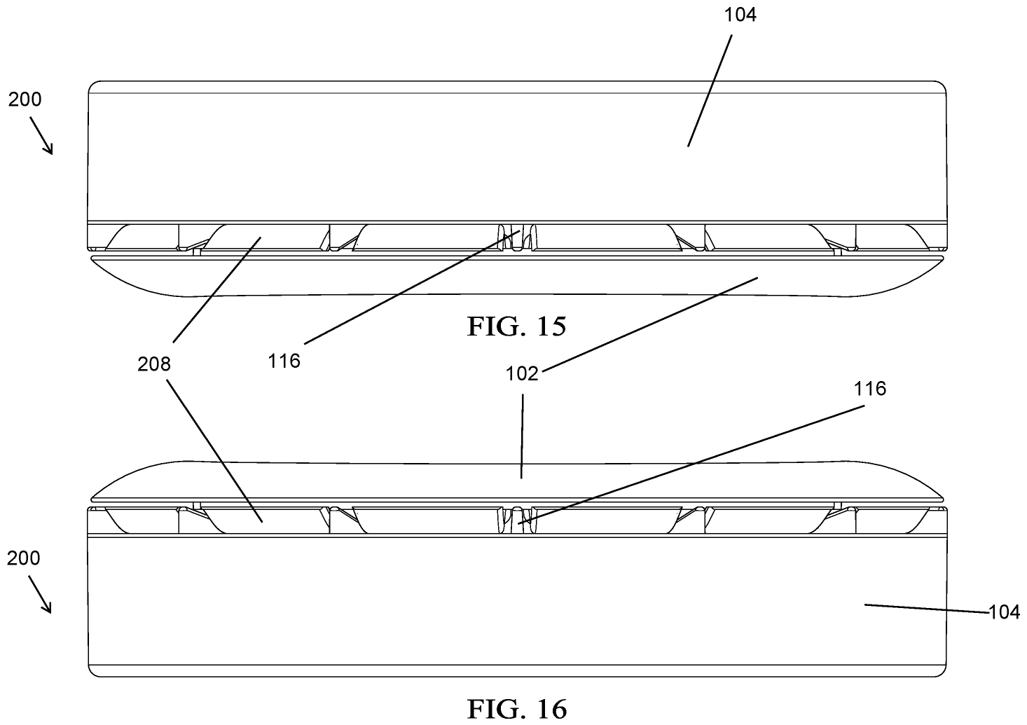

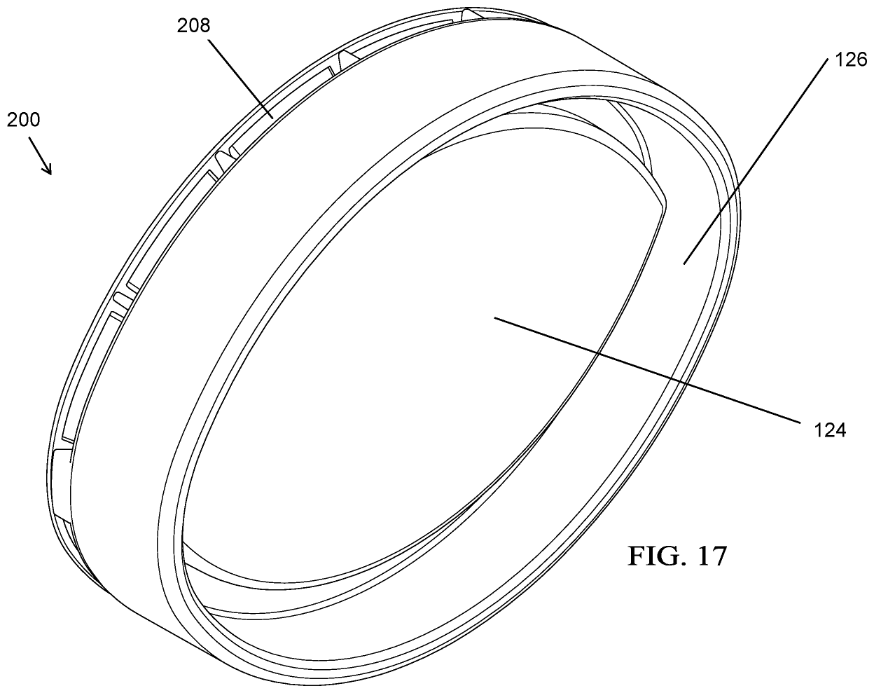

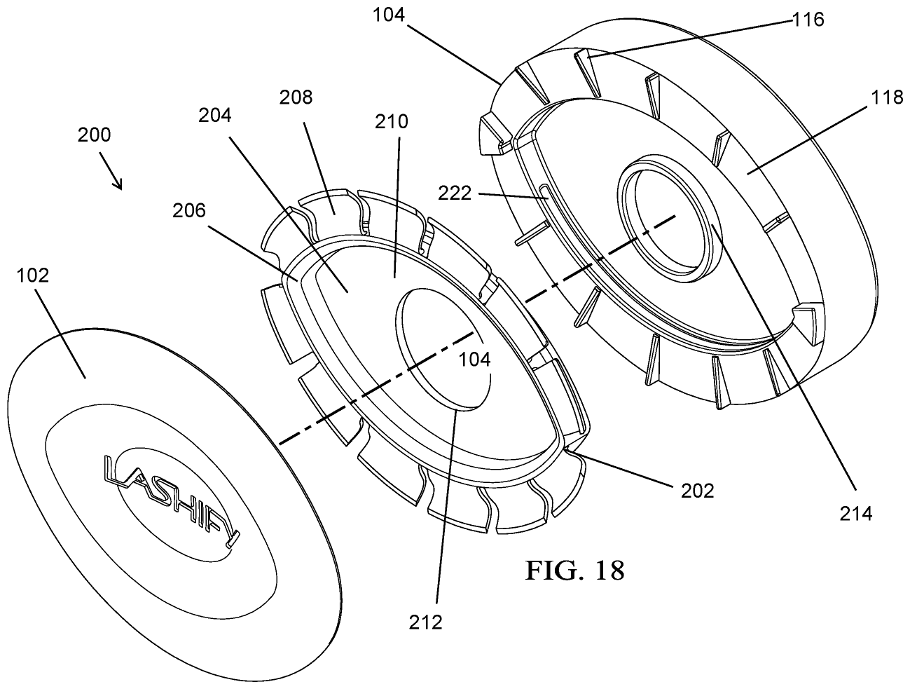

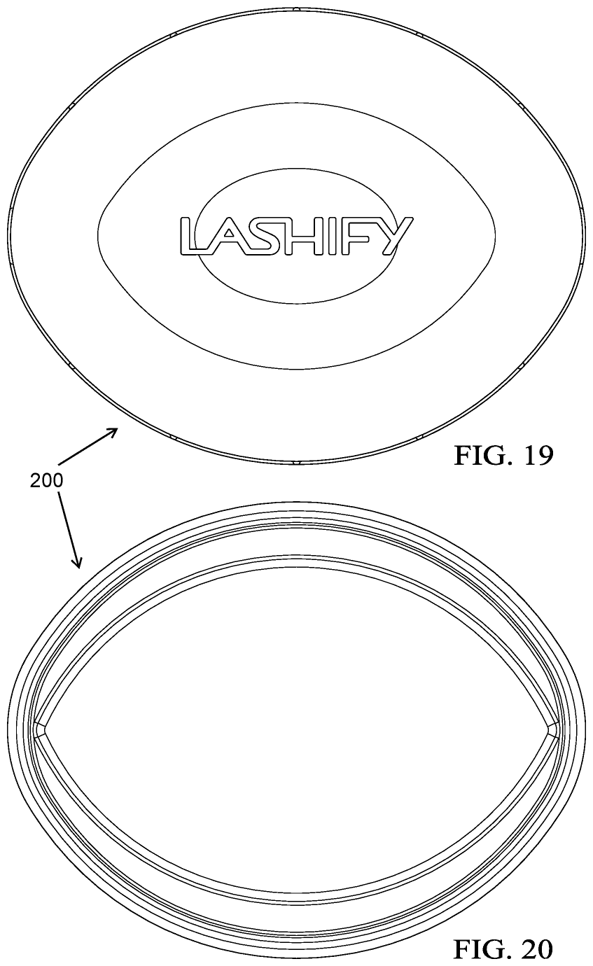

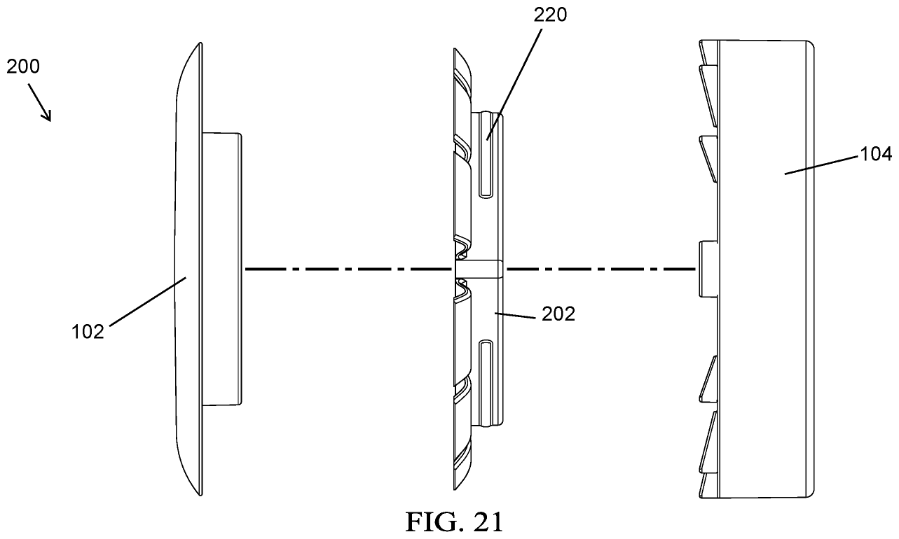

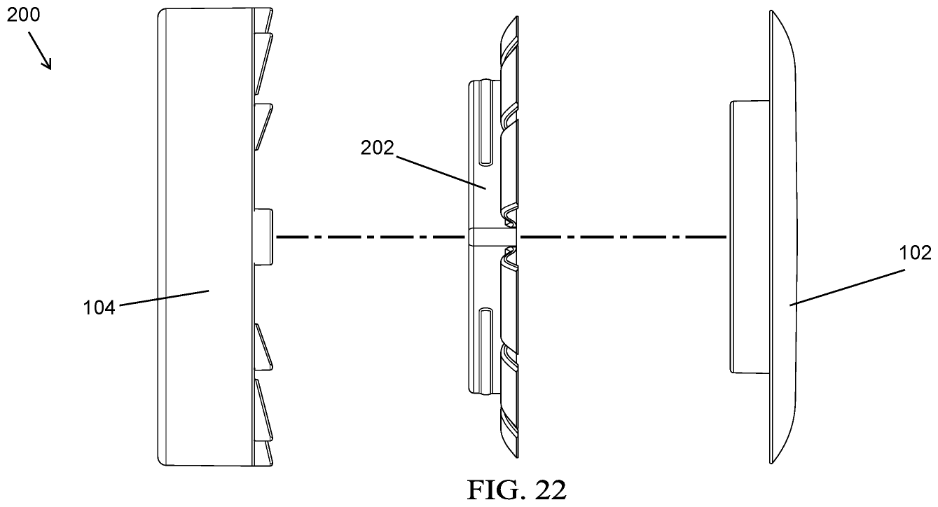

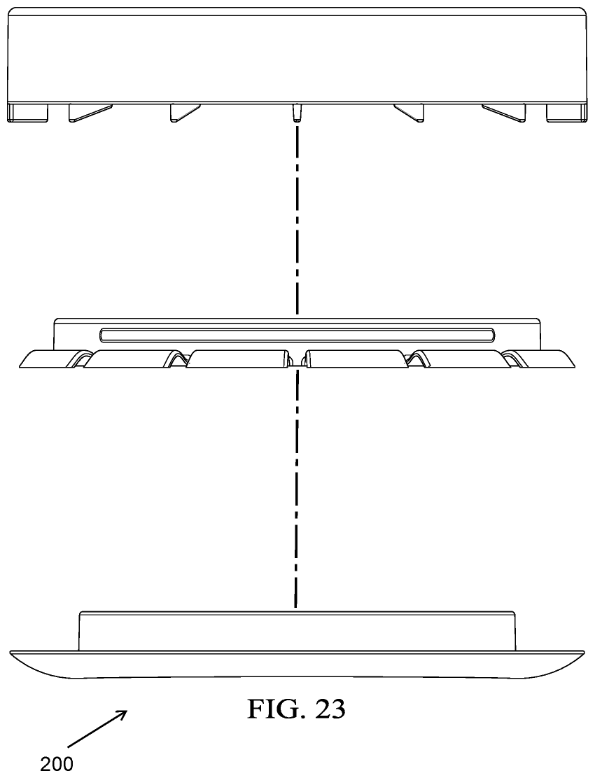

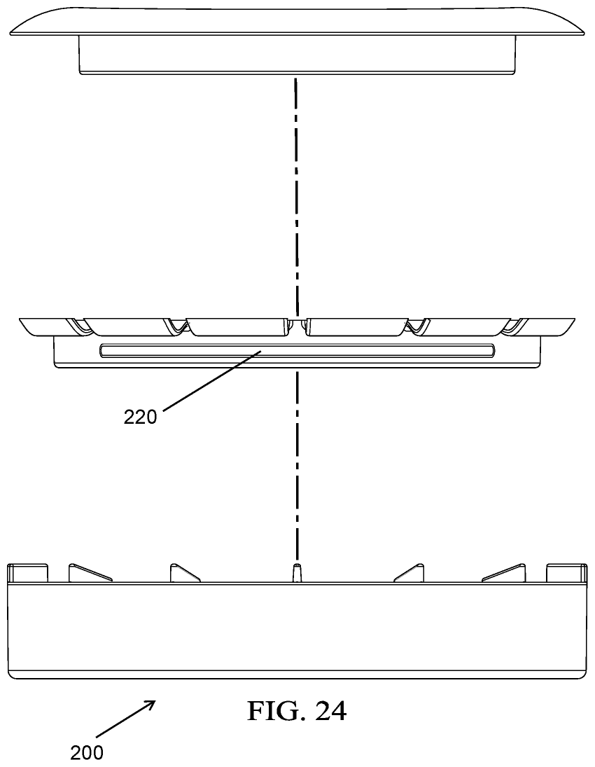

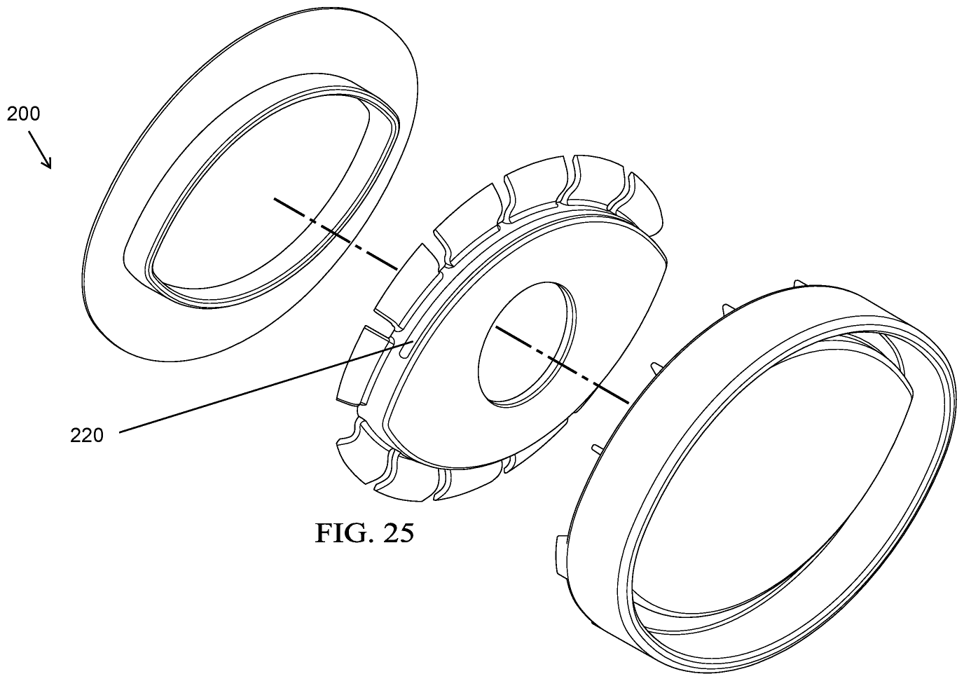

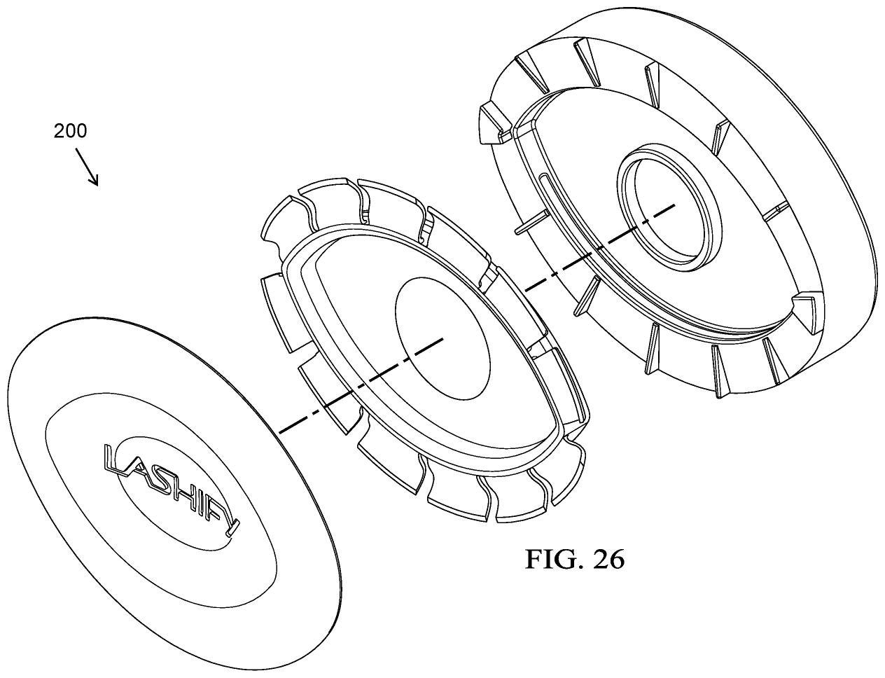

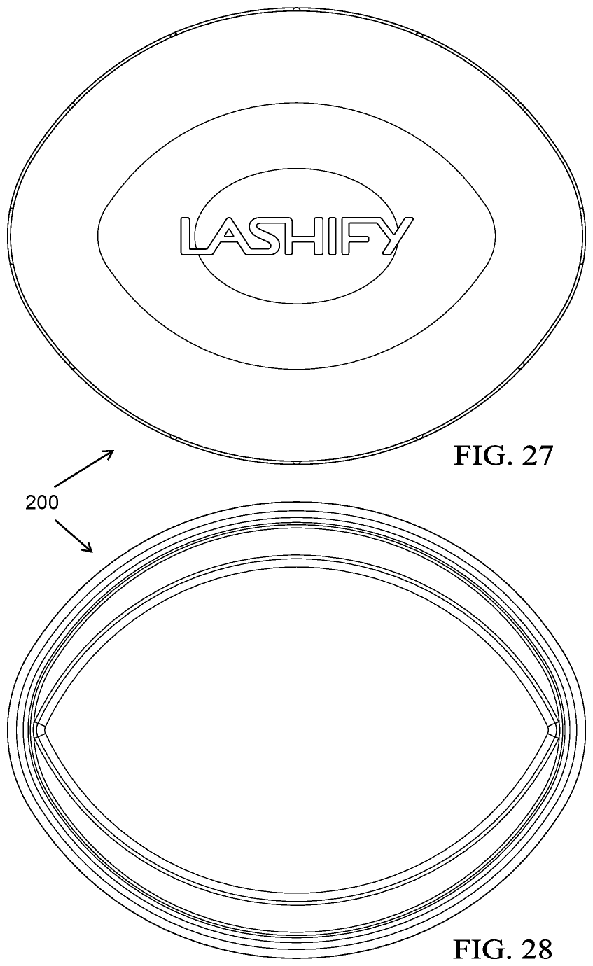

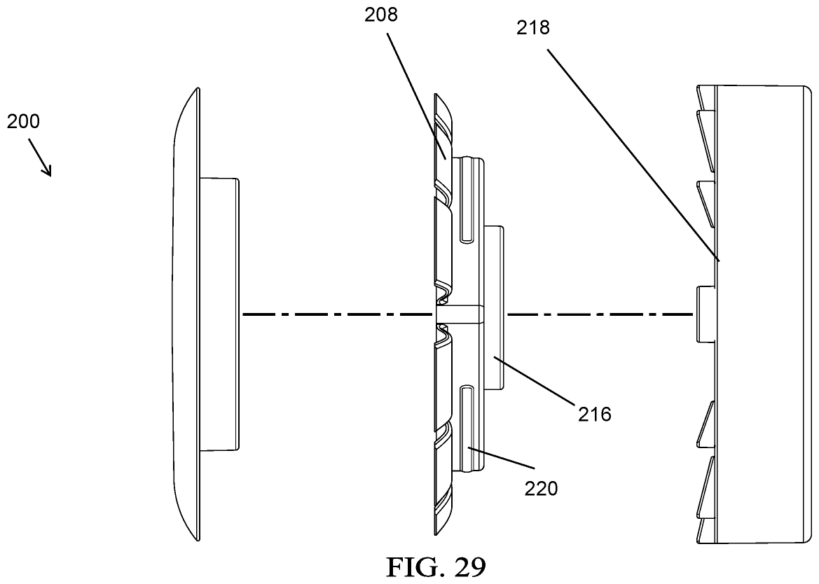

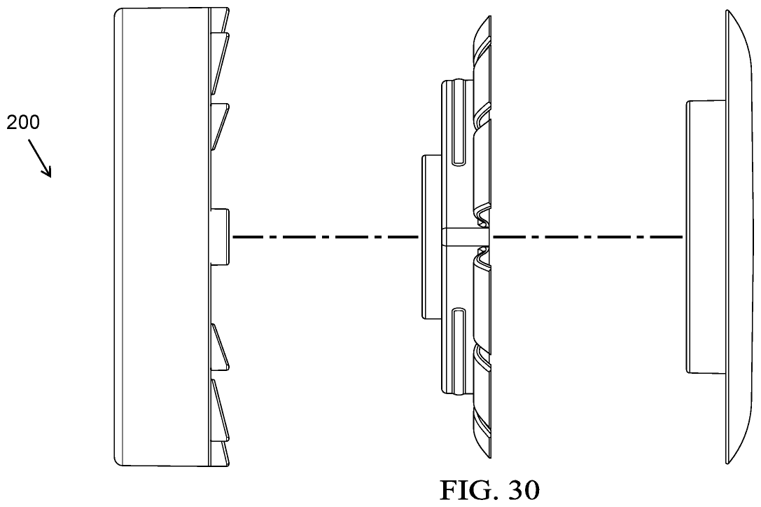

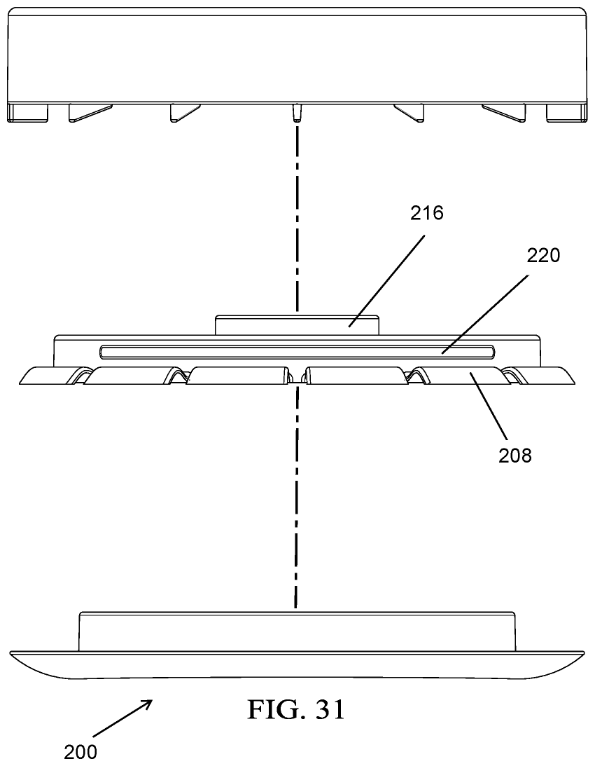

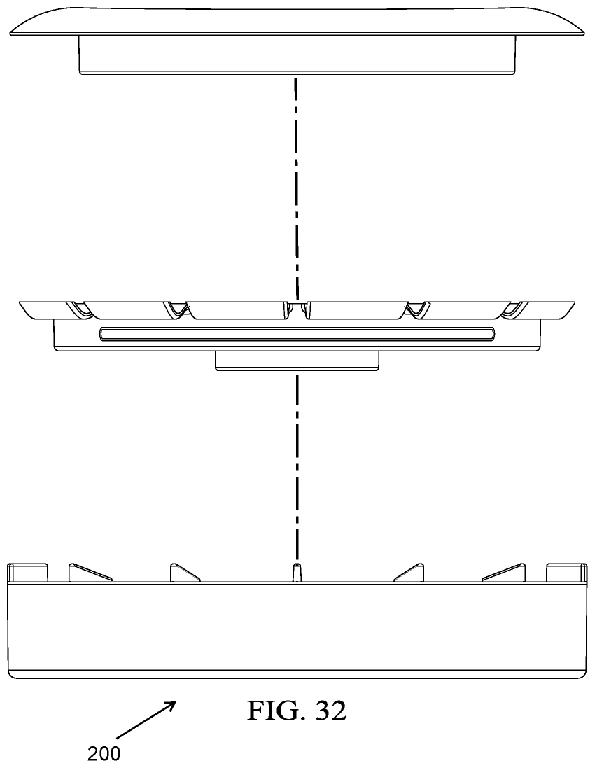

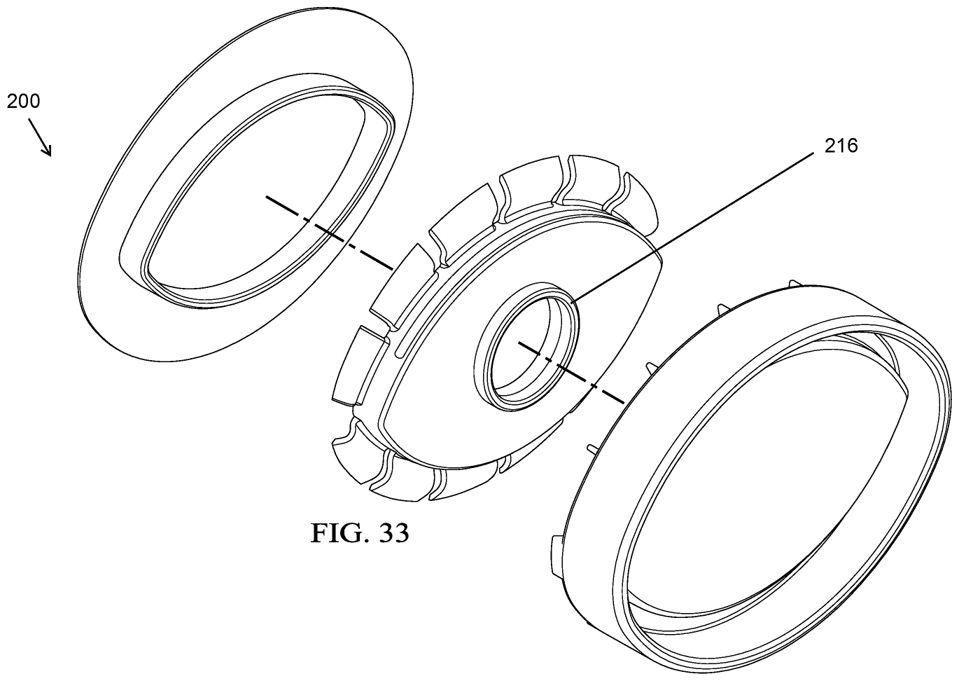

FIGS. 10-33 show an embodiment of a case where a gasket is separate and distinct from a lid and a body according to this disclosure. A case 200 is similar to the case 100 in size and function, but has some notable differences. In particular, the case 200 has the lid 102 and the body 104 being separate and distinct from a gasket 202, as shown in FIGS. 18, 21-26, and 29-33. Further, the inner central floor 124 is spaced apart from the sidewall 114, as shown in FIGS. 12, 17, 20, 25, 28, and 33, which can be beneficial from usage of less material. Also, the gasket 202 mates with the body 104 or vice versa, as shown in FIGS. 18, 21-26, and 29-33.

The gasket 202 has a floor 204, a sidewall 206, and a plurality of tabs 208. The floor 202 is monolithic, but can be assembled (e.g., puzzle, mated, interlocked, adhered, magnetized, fastened). The sidewall 206 is monolithic, but can be assembled (e.g., puzzle, mated, interlocked, adhered, magnetized, fastened). At least one of the tabs 208 is monolithic, but can be assembled (e.g., puzzle, mated, interlocked, adhered, magnetized, fastened). At least one of the floor 204, the sidewall 206, or at least one of the tabs 208 includes plastic, metal, rubber, foam, alloy, wood, or others. The tabs 208 should be flexible or deformable to maintain lash extensions in the slot 118, as further provided herein.

The floor 204 is eye-shaped, but can be shaped differently, whether open-shape or closed-shaped, whether symmetrical or asymmetrical (e.g., square, rectangle, circle, oval, triangle, pentagon, hexagon, octagon, U-shape, C-shape, D-shape). The sidewall 206 extends from the floor 204 such that an internal cavity 210 is defined thereby. The sidewall 206 is monolithic with the floor 204, but can be assembled therewith (e.g., fastened, mated, interlocked, magnetized). The sidewall 206 is eye-shaped, but can be shaped differently, whether open-shape or closed-shaped, whether symmetrical or asymmetrical (e.g., square, rectangle, circle, oval, triangle, pentagon, hexagon, octagon, U-shape, C-shape, D-shape). As such, the cavity 210 is eye-shaped, but can be shaped differently, whether open-shape or closed-shaped, whether symmetrical or asymmetrical (e.g., square, rectangle, circle, oval, triangle, pentagon, hexagon, octagon, U-shape, C-shape, D-shape). The floor 204 has a central opening 212, but can avoid the central opening 212. The central opening 212 is circular, but can be shaped differently, whether open-shape or closed-shaped, whether symmetrical or asymmetrical (e.g., square, rectangle, circle, oval, triangle, pentagon, hexagon, octagon, U-shape, C-shape, D-shape).

The tabs 208 are spaced apart from each other and radially and cantileveredly extend from the sidewall 206 away from the cavity 210 not over the floor 204 or the cavity 210. For example, at least one of the tabs 208 extends from the sidewall 206 in an L-shaped manner. The tabs 208 can be visible from frontally looking into the windows 122. The tabs 208 are monolithic with the sidewall 206, but can be assembled therewith (e.g., fastened, mated, interlocked, magnetized). The tabs 208 are V-shaped, but can be shaped differently, whether open-shaped or closed-shaped, whether symmetrical or asymmetrical (e.g., I-shaped, L-shaped, U-shaped, C-shaped, W-shaped, M-shaped, D-shaped, S-shaped, J-shape, Y-shaped, P-shaped). For example, since the tabs 208 are V-shaped, each of the tabs 208 has a central apex which can resiliently engage a respective artificial lash extension 110 within a respective slot 118 to resiliently secure the respective lash extension 110 within the respective slot 118.

As shown in FIGS. 18, 21-26, and 29-33, the gasket 202 can be sandwiched between the lid 102 and the body 104 when the lid 102 is coupled to the body 104 and the artificial lash extensions 110 are positioned within the slots 118 and the wall 130 faces, contacts, or engages the floor 204 around the central opening 212, while the floor 204 is positioned between the protruding area 128 of the lid 102 and the floor 124 of the body 104. As such, the tabs 208 extend within the slots 118 between the partitions 116 over the floors 120 such that the tabs 208 resiliently engage the artificial lash extensions 110 within the slots 118, thereby resiliently securing the artificial lash extensions 110 within the slots 118. Therefore, when a user desires to remove an artificial lash extension 110 from a slot 118, whether by hand or via an applicator, as the artificial lash extension 110 is resiliently secured within the slot 118 via a tab 208, the user can pull the artificial lash extension 110 in a direction (e.g., radial, lateral) away from the tab 208 such that the artificial lash extension 110 slides out from the tab 208 and the slot 118. Alternatively or additionally, the user can lift the tab 208 in order to resiliently unsecure the artificial lash extension 110 and then pull the artificial lash extension 110 in a direction (e.g., radial, lateral) away from the tab 208 such that the artificial lash extension 110 slides out from the slot 118. In an embodiment, the lid 102 may be configured to be pressed against the gasket 202 to cause the gasket 20 to be pushed down so that tabs 208 apply pressure to the lash extensions 110 disposed between the tabs 208 and floor 118. If the lid 102 is raised, but not removed from the body 104, then pressure to the gasket 202 may be reduced, thereby resulting in less pressure from the tabs 208 onto the lash extensions 110.

Although the tabs 208 are shown in a one-to-one correspondence with the slots 118, this can vary (e.g., multiple tabs 208 within single slot 118). Further, although the tabs 208 are spaced apart from each other thereby defining the tabs 208, this configuration can vary and there can be a single tab 208 per plurality of slots 118 (e.g., tabs 208 are not spaced apart from each other thereby defining single tab 208). Additionally, note that the inwardly dimpled portion 126 can be axially co-aligned with the central opening 212 and the male portion 214 (e.g., axis of symmetry, axis of rotation).

When the body 104 has a male portion 214 (e.g., projection, column, pedestal), whether internally hollow or solid, then the gasket 202 can mate with the body 104 via the male portion 214 being inserted, which can also include fastening, into the central opening 212, as shown in FIGS. 18, 21-26, and 29-33, or vice versa. However, a reverse is possible as well, where the gasket 202 has a male portion 216 (e.g., column, pedestal), whether internally solid or hollow) and the body 104 has a central opening 218. As such, the gasket 202 can mate with the body 104 via the male portion 216 being inserted, which can include fastening, into the central opening 218, as shown in FIGS. 18, 21-26, and 29-33, or vice versa. Note that the opening 212 or the opening 218 can be non-central as well. As such, the male portion 214 or 216 can be non-central as well.

The gasket 202 can snugly or non-snugly rest within the body 104. As shown in FIGS. 18, 21-26, and 29-33, the sidewall 206 hosts a plurality of mating portions 220. As such, if the mating portions 220 are male (e.g., projection, column, pedestal), then the inner side of the wall 126 has a plurality of female portions 222 (e.g., depressions, openings) that can mate with the mating portions 220. Conversely, if the mating portions 220 are female (e.g., depressions, openings), then the inner side of the wall 126 has a plurality of male portions (e.g., projection, column, pedestal) that can mate with the mating portions 220. As such, this enables the gasket 202 to snugly rest within the body 104. For example, the gasket 202 can snap fit into the body 104 or vice versa. However, if the mating portions 220 are absent, then the gasket 202 can non-snugly (e.g., freely) rest within the body 104. Further, note that due to shaping of the body 104 and the gasket 202, the gasket 202 can still be snug within the body 104. For example, due to eye-shaping of the gasket 202 and the body 104, the gasket 202 can still remain snug and not be able to rotate within the body 104 unless the gasket 202 is removed from the body 104 and then be rotated and then be inserted back. Note that the mating portion 220 can be spaced apart from each other or the mating portions 220 can avoid being spaced apart from each other such that a single mating portion 220 is defined. In an embodiment, the gasket 202 may be part of or connected to the lid 102 so that the case is formed of two or effectively two components (i.e., the body 104 and lid/gasket 102/202).

One embodiment of a method of manufacturing a case for carrying artificial eyelash extensions may include providing a lid, providing a gasket, and providing a body. The lid may be coupled to the body such that the body and the lid define a window. The gasket may be coupled to either the lid or the body between the lid and the body, where the window may be configured to enable a lash extension having a base and a plurality of hairs that extend out of the window as the gasket resiliently contacts the base or the hairs.

This disclosure is was described with reference to FIGS. 1-33, in which some embodiments of this disclosure are shown. This disclosure may, however, be embodied in many different forms and should not be construed as necessarily being limited to the embodiments disclosed herein. Rather, these embodiments are provided so that this disclosure is thorough and complete, and fully conveys various concepts of this disclosure to skilled artisans.

Various terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

As used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

Furthermore, relative terms such as “below,” “lower,” “above,” and “upper” can be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. Also, as used herein, the term “a” and/or “an” shall mean “one or more,” even though the phrase “one or more” is also used herein. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof. Furthermore, when the present disclosure states herein that something is “based on” something else, then such statement refers to a basis which may be based on one or more other things as well. In other words, unless expressly indicated otherwise, as used herein “based on” inclusively means “based at least in part on” or “based at least partially on.”

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (30) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, a gemstone, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical to and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

As used herein, the term “about” and/or “substantially” refers to a +/−10% variation from the nominal value/term. Such variation is always included in any given value/term provided herein, whether or not such variation is specifically referred thereto.

If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

Although preferred embodiments have been depicted and described in detail herein, skilled artisans can make various modifications, additions, substitutions and the like can be made without departing from this disclosure, and these are, therefore, considered to be within scope of this disclosure, as claimed.

1. A case comprising:
a lid;
a gasket; and
a body coupled to the lid such that the body and the lid define a window and such that the gasket is positioned between the lid and the body, the window being configured to enable a lash extension having a base and a plurality of hairs that extend out of the window as the gasket resiliently contacts the base or the hairs.

2. The case of claim 1, wherein the lid has an inner side, wherein the gasket is coupled to the inner side.

3. The case of claim 1, wherein the lid has an outer side hosting a visual indicia disposed thereon, wherein the visual indicia is an orientation indicia.

4. The case of claim 1, wherein the lash extension is a first lash extension, wherein the base is a first base, wherein the hairs is a first plurality of hairs, and further including a second lash extension having a second base and a second plurality of hairs, wherein the second hairs extend from the second base, wherein the second hairs extend out of the window as the gasket contacts the second base or the second hairs.

6. The case of claim 4, wherein the first hairs and the second hairs are positioned co-planar.

7. The case of claim 1, wherein the body has a floor leading to the window, wherein the floor supports the base and the hairs when the lid is not coupled to the body, wherein the floor is inclined.

8. The case of claim 7, wherein the floor is inclined outwardly.

9. The case of claim 1, wherein the body has a floor leading to the window, wherein the floor supports the base and the hairs when the lid is not coupled to the body, wherein the floor has a rough portion.

10. The case of claim 1, wherein the window is a member of a group of windows defined by the body and the lid when the body is coupled to the lid.

11. The case of claim 1, wherein the lid has an inner side hosting a wall extending therefrom, wherein the base extends between the window and the wall, wherein the gasket extends at least partially between the wall and the window.

12. The case of claim 1, wherein the gasket is an elastic band.

13. The case of claim 1, wherein the gasket is resilient.

14. The case of claim 1, wherein the gasket is continuous.

15. The case of claim 1, wherein the lid has an inner side hosting a wall extending therefrom, wherein the base extends at least partially between the window and the wall, wherein the gasket extends at least partially between the wall and the window, wherein the gasket is generally closed-shaped but specifically shapeless before mounting over the wall and then specifically shaped when mounted over the wall to shapely correspond to the wall.

16. The case of claim 1, wherein the lid has an inner side hosting a wall extending therefrom, wherein the base extends between the window and the wall, wherein the gasket extends between the wall and the window, wherein the gasket is specifically shaped before mounting over the wall to correspond to the shape of the wall.

17. The case of claim 1, wherein the lid has an inner side hosting a wall extending therefrom, wherein the base extends between the window and the wall, wherein the gasket extends between the wall and the window, wherein the gasket remains in place via an elastic friction against the wall or inward pressure against the wall.

18. The case of claim 1, wherein the lid has an inner side hosting a wall extending therefrom, wherein the base extends between the window and the wall, wherein the gasket extends between the wall and the window, wherein the gasket is secured to the wall.

19. The case of claim 1, wherein the lid hosts a plurality of protrusions spaced apart from each other and extending along the gasket, wherein at least one of the protrusions engages the base or the hairs when the body is coupled to the lid, wherein the at least one of the protrusions is positioned between the gasket and the window when the body is coupled to the lid.

20. The case of claim 19, wherein the at least one of the protrusions an area proximal to the gasket, wherein the area is configured to help in frictionally limiting a movement of the lash extension when the area contacts the lash extension.

21. The case of claim 1, wherein the hairs extend out of the window as the gasket resiliently contacts the base or the hairs.

22. The case of claim 1, wherein the gasket is separate and distinct from the lid and the body.

23. The case of claim 22, wherein the gasket includes a wall and a plurality of tabs, wherein the tabs radially extend from the wall, wherein at least one of the tabs contacts the base or the hairs.

24. The case of claim 23, wherein the at least one of the tabs has a projection that contacts the base or the hairs.

25. The case of claim 24, wherein the at least one of the tabs extends from the wall in an L-shape manner.

26. A method of manufacturing a case for carrying artificial eyelash extensions, said method comprising:
providing a lid;
providing a gasket;
providing a body; and
coupling the lid to the body such that the body and the lid define a window;
coupling the gasket to either the lid or the body between the lid and the body, the window being configured to enable a lash extension having a base and a plurality of hairs that extend out of the window as the gasket resiliently contacts the base or the hairs.
